(19) United States
(12) Patent Application Publication
(10) Pub. No.: US 2023/0145427 A1
(43) Pub. Date: May 11, 2023

(54) OFF-ROAD LIGHTING CONTROL SYSTEMS AND METHODS

(71) Applicant: Ford Global Technologies, LLC, Dearborn, MI (US)

(72) Inventors: Casey Ray, Ypsilanti, MI (US); Jason F. Cauley, Milford, MI (US); Dakota Drake Legge, South Lyon, MI (US); Allan Fisher, Charlotte, MI (US)

(73) Assignee: Ford Global Technologies, LLC, Dearborn, MI (US)

(21) Appl. No.: 17/523,103

(22) Filed: Nov. 10, 2021

(51) Int. Cl. B60Q 1/14; B60Q 1/00; B60Q 1/18; H05B 47/105

(52) U.S. Cl. CPC B60Q 1/1423; B60Q 1/0035; B60Q 1/0041; B60Q 1/18; H05B 47/105; B60Q 1/2661

(57) ABSTRACT

Off-road lighting control systems and methods are disclosed herein. An example vehicle can include off-road lighting mounted to an outside of the vehicle, as well as a controller including a processor and memory. The processor executes instructions in memory to determine a category of a road that the vehicle is located on using location-based information and automatically control the off-road lighting based on the category of the road.

### BACKGROUND

Vehicle owners may install aftermarket lamps to enhance off-road lighting on their vehicles. Thus, some off-road lighting may not be integrated into the original control systems of the vehicle and the vehicle owner may not be reminded about the operational status of these lights as would be the case with factory-installed lighting.

Further, improper use of off-road lighting may result in undesired effects. For example, if off-road lighting were to be activated on public roads, such as a highway or arterial road, such use may not be desirable for pedestrians or drivers in oncoming vehicles. Also, a driver may be unaware or forget when the off-road lighting is activated. The driver may inadvertently leave their off-road lighting on after off-roading use where the off-road lighting was permitted. Unauthorized use of off-road lighting may be discouraged in some locations.

### BRIEF DESCRIPTION OF THE DRAWINGS

A detailed description is set forth regarding the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example architecture where the systems and method of the present disclosure may be practiced.

FIG. 2 is a screenshot of a graphical user interface illustrating a zone diagram of off-road lighting.

FIG. 3 is a screenshot of a graphical user interface where a user can select individual off-road lighting elements.

FIG. 4 is a screenshot of a graphical user interface comprising a message requesting user confirmation of off-road auxiliary (ORA) lighting use.

FIG. 5 illustrates an example off-road environment where a message can be displayed to a user on a human-machine interface.

FIG. 6 is another example graphical user interface that can be displayed to a user on a human-machine interface.

FIG. 7 is a flowchart of an example method of the present disclosure.

FIG. 8 is a flowchart of another example method of the present disclosure.

### DETAILED DESCRIPTION

### Overview

The present disclosure pertains to off-road lighting control systems and methods of use. The off-road lighting may include factory-installed (e.g., original equipment manufacturer) off-road lighting that includes features that ensure the lighting does not cause deleterious effects during use. While factory-installed off-road lighting is an example, aspects of the present disclosure can be used to control after market-installed off-road lighting as well.

Thus, the systems and methods disclosed herein provide for an improved auxiliary lighting system for a vehicle. Example systems provide a smart user interface where off-road auxiliary lights can be turned on or off as desired by a user, provided certain conditions are met to enable the lights. To determine if acceptable conditions are met, the lighting system monitors the vehicle's on/off-road status by comparing the vehicle's GPS location to a map database within the vehicle's navigation system. The lighting system then establishes if the vehicle is on a road, and if it is on a road, the lighting system may then determine which level of lighting restriction should be used. In one example configuration, when the vehicle is on a freeway or highway, all off-road auxiliary lights are disabled. On other roads, such as arterials, connectors, or the like, lights may be turned on by the user, but the lighting system can monitor for other vehicles or hazards and can turn off all or a portion of the off-road auxiliary lights until a hazard has passed or is otherwise no longer detected. When the vehicle is off-road, there are no restrictions; off-road auxiliary lights may be turned on/off by a user as desired, without restriction.

The availability of different types of auxiliary lighting and any associated restrictions may be presented on a graphical user interface presented through a human-machine interface of the vehicle. Additionally, the user interface may prompt the user to confirm the location of the vehicle. Additional driver-assist technologies may also come into play. For example, lane sensing systems may be used to disable particular lights if lane markings are detected. Oncoming vehicle sensing may be used to disable particular lights when oncoming traffic is detected.

In some configurations, aspects of the present disclosure are implemented using a software/GPS approach to equipping vehicles with factory-installed off-road auxiliary lighting that does not impair the effectiveness of the required vehicle lighting. Example strategies can be implemented to ensure that the customer has made a conscious decision to enable the off-road lighting after acknowledging the proper use of lights.

Since GPS and road map data is not always consistent and does not accurately account for off-road vehicle designated areas, an automatic off-road lighting control mode gives customers leeway to operate the lighting while preventing blinding and distracting others.

### Illustrative Embodiments

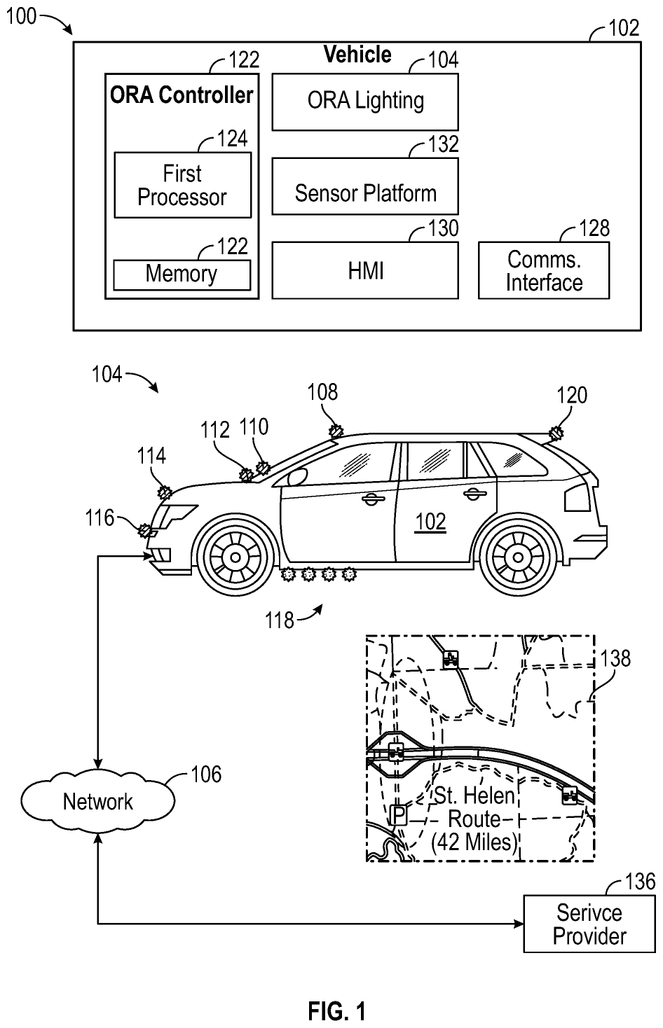

Turning now to the drawings, FIG. 1 depicts an illustrative architecture 100 in which techniques and structures of the present disclosure may be implemented. The architecture 100 includes a vehicle 102 having factory-installed ORA lights 104 that can be manually and/or automatically controlled as disclosed herein. The vehicle 102 may include a smart vehicle that is configured to transmit and/or receive data over a network 106. The network 106 can include combinations of networks. For example, the network 106 may include any one or a combination of multiple different types of networks, such as cellular, cable, the Internet, wireless networks, and other private and/or public networks. The network can include both short and long-range wireless networks.

The ORA lighting 104 can include a plurality of individual lighting elements. The off-road auxiliary lighting can include but is not limited to roof bar lighting 108, mirror or A-pillar lighting 110, cowl bar lighting 112, hood lighting 114, bumper lighting 116, undermount lighting 118, and rear spot lighting 120—just to name a few. Lighting elements 108-116 are more likely to be used in situations where vehicle speeds exceed 15 miles per hour, such as during Baja mode use (where vehicle is driven off-road at high speeds in sand or other similar conditions). Undermount lighting 118 may produce less glare than rear spot lighting 120, however, both of these types of lighting are likely to be used in low-speed off-roading conditions.

An automatic ORA controller (hereinafter “controller 122”) can be used to control the various types of ORA lighting on the vehicle. The controller 122 can include a processor 124 and memory 126. The processor 124 executes instructions stored in memory 126 to perform the functions and methods as disclosed herein, namely automated ORA lighting control. When referring to actions performed by the vehicle 102, the controller 122, and/or the processor 124, this includes the execution of instructions by the processor 124. A communications interface 128 can be used by the processor 124 to transmit and/or receive data over the network 106. For example, the controller 122 can obtain navigation data from a service provider 136.

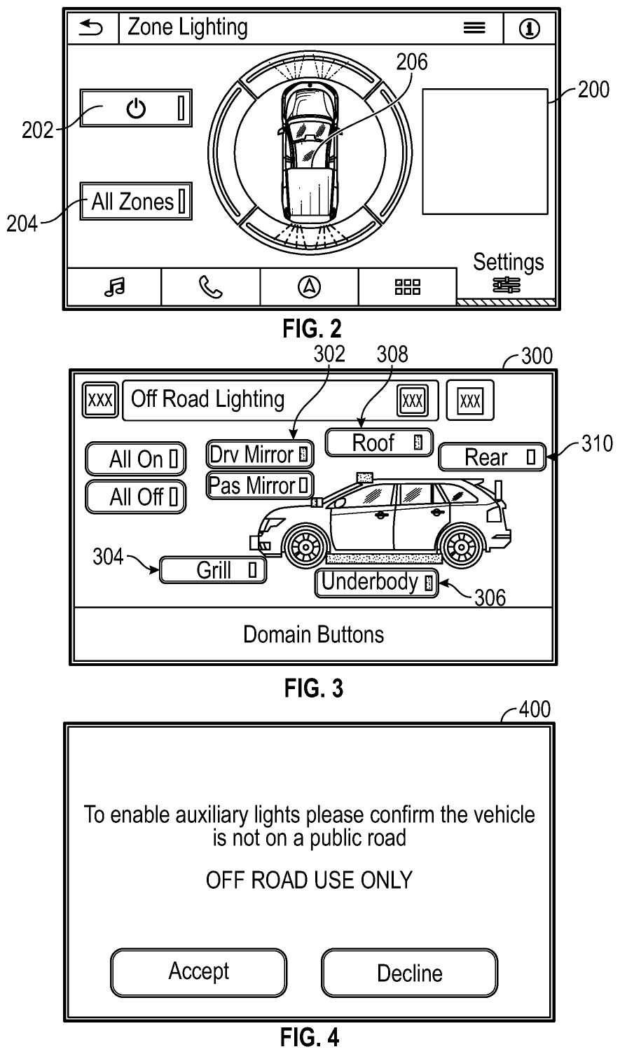

In some instances, the vehicle 102 can include a human-machine interface (HMI) 130 that can include an interactive screen associated with an instrument cluster or an infotainment system of the vehicle 102. The FIGS. 2-4 illustrate various interactive graphical user interfaces (GUI) that can be displayed on the HMI 130. In FIG. 2, a GUI 200 can include a zone lighting diagram where a user can select to turn on/off an ORA lighting mode (allows for automated ORA lighting control) using a button 202. All zones of ORA lights can be activated or deactivated using button 204. A vehicle avatar 206 illustrating ORA light zone illumination can be displayed to inform the user when ORA lights are active or not.

Another example GUI 300 is illustrated in FIG. 3, which allows for more granular control over ORA lighting elements. The GUI 300 can include various buttons for toggling on/off lights such as mirror lights 302, grill lights 304, underbody lights 306, roof lights 308, rear lights 310, and so forth. One or more buttons can be included to toggle all lights on/off. In some instances, the user can toggle ORA lights on or off using a physical actuator such as a switch or button. The vehicle controller 122 (FIG. 1) can determine the status of the ORA lights based on the position of the physical actuator.

When the user has selected which ORA lights they wish to use, a confirmation message with selectable answers can be displayed on a GUI 400 as illustrated in FIG. 4. The GUI 400 causes the user to make a deliberate choice to activate the selected ORA lights. As will be discussed below, this type of confirmatory choice may be used in instances where the vehicle has been determined by the controller 122 to be operating on a specific category of road. In some instances, the user can confirm their intent to use ORA lights when ORA light feature is initiated and need not be requested again during use.

In some instances, the controller 122 can activate an ORA mode based on user input. For example, if the user selects to activate ORA lighting through a user interface, the controller 122 can receive that actuation from the HMI 130 and activate an ORA mode. Alternatively, the controller 122 can activate ORA mode based on an interlock. In general, an interlock corresponds to a state of a vehicle sub-system or component, which can be used by the controller 122 to determine if ORA lighting should or should not be active.

One example interlock can include the user selecting an off-road drive mode for the vehicle such as mud/rock/sand/snow mode, crawl, Baja, and so forth. The controller 122 can use the selected drive mode as a basis for automatically activating or deactivating ORA lighting. Another example interlock can include the user selecting a particular transmission drive-line state such as four-high, four-low, two-low and the like. The transmission drive-line state is indicative of the vehicle being used in an off-road setting. The controller 122 can use the transmission drive-line state as a basis for automatically activating or deactivating ORA lighting. In yet another example, the controller 122 can use images obtained by a vehicle camera to identify street signs or other roadside indicia that may indicate where the vehicle is located. For example, a street sign may indicate if the vehicle is on a particular road or highway. Another example sign that may indicate an off-road path could include a trailhead sign.

Another example interlock can include a speed or velocity limit. For example, when the vehicle is operating above a speed or velocity limit, it is assumed that the vehicle is not being used (or should not be being used) in an off-road manner. In one instance, the speed or velocity limit can be approximately 20 kph/12.4 mph miles per hour, however, this value can vary according to vehicle operating parameters. When the vehicle speed is greater than the velocity limit, the controller 122 can activate the automatic ORA mode. When the vehicle speed is greater than the velocity limit and the vehicle is in a permitted location (and the user has confirmed that ORA lights can be used), the ORA lights may remain on.

Another example of interlock includes a geolocation of the vehicle. The controller 122 can use the geolocation of the vehicle as a basis for automatically activating or deactivating ORA lighting. For example, if the controller 122 determines that the vehicle is on a highway, the controller 122 can deactivate or block ORA lighting from being activated. If the controller 122 determines that the vehicle is on an off-road trail, the controller 122 can activate ORA lighting automatically, or allow a user to activate the ORA lighting.

To be sure, the controller 122 can be configured to monitor one or more of these interlocks in real-time or near-real time to determine interlock changes and automatically control ORA lighting in response. Additional examples of autonomous ORA lighting control are disclosed in greater detail infra.

As noted above, the controller 122 can be configured to use an ORA mode of vehicle control where the controller 122 can activate or deactivate ORA lighting. In one example, the controller 122 can activate or deactivate ORA lighting based on a category of road on which the vehicle is currently operating. For example, the controller 122 can determine a geolocation of the vehicle 102 based on GPS or other location-based information obtained from an on-board component or over the network 106. The communications interface 128 can be used to obtain GPS signals, which are then used by the controller 122 to determine a vehicle location. In more detail, the controller 122 can compare the location of the vehicle to road information associated with a navigation map 138. The map information can be obtained from an on-board navigation system or from a resource that the controller 122 can couple with over the network 106. The map can include features such as roads, trails, and other information. The controller 122 can locate the vehicle on the map and obtain information regarding the current location of the vehicle. To be sure, some maps may include specific information regarding ORV/ORA trails.

The controller 122 may determine that the vehicle 102 is located on a highway, a city street, an off-road trail, or other location. The controller 122 can classify a location of the vehicle as being correlated to a particular category of a road.

Example categories can include but are not limited to a first category of road that comprises any of an interstate, a freeway, or an expressway. Broadly, a first category of road can be any road where the use of ORA lighting is strictly prohibited by motor vehicle codes or laws. ORA lighting use strictly prohibited by means of a hard interlock when the vehicle in on a first category road.

A second category of road comprises any of a principle or minor arterial, a principle or minor collector, or another similar type of road. In general, a second category of road can be any road where use of ORA lighting may be permitted, based on one or more conditions. When the controller 122 determines that the vehicle is on a second category of road, the controller 122 can request that a user make a deliberate decision to use the ORA lights. In one example, this decision can be evidenced by the user removing factory-installed off-road light covers. For example, each ORA light may be associated with a cover. The controller 122 can determine when the cover is in place or removed from the ORA light using a sensor. When the cover and ORA light couple with a clasp or other securement element, the sensor may detect when the cover and ORA light are engaged with one another. In some instances, controller 122 can determine when the user has acknowledged a disclaimer that the lights are to be used off-road only when accessing the ORA menu presented on the HMI 130. While these categories have been set forth as examples, these examples are not intended to be limiting.

Also, when the vehicle is determined to be on a second category road, the controller 122 can be configured to disable a portion of the ORA lighting. For example, lights that are likely to cause high levels of glare, such as lights mounted on, or directed towards, a front of the vehicle may be disabled. Other ORA lights may remain on, such as underbody or rear-facing ORA lighting.

In some instances, the controller 122 can enable or activate ORA lights when the vehicle is at or below the speed or velocity threshold as mentioned above. For example, ORA lights may only be used without restriction under 12.4 miles per hour, in some instances. However, an automatic ORA mode can be activated when the vehicle speed exceeds 12.4 miles per hour.

A third category of road comprises any of an off-road vehicle (ORV) road, a trail, or private property. The third category of road can be any road where use of ORA lighting is always permitted, but may be discretionarily disabled (either manually by a user or automatically by the controller 122) for various reasons, as will be discussed herein. In general, the controller 122 can implement similar logic that is used with respect to second category roads, with the exception that speed thresholds may not be used. This is due to the fact that the vehicle may operate about the speed/velocity threshold when performing some off-roading techniques. It will be understood that while three categories of roads have been disclosed for use, the number and configuration of logic for these categories can be varied as desired.

The automatic ORA mode can be used to activate or deactivate ORA lights based on the detection of hazards or other driving conditions when the vehicle is operating on a second category of road. For example, the automatic ORA mode used by the controller 122 can utilize a modified automatic high-beam algorithm. In one example, ORA lights deactivated under certain conditions, including, but not limited to the detection of oncoming and leading vehicles, parked vehicles, bicycles, pedestrians, and other similar conditions. In some instances, the controller 122 can determine ORA lighting deactivating conditions using one or more sensors of a sensor platform 132 associated with the vehicle 102. For example, the sensor platform can include a sunlight sensor (senses ambient sunlight or street light), cameras, LIDAR (light imaging and ranging), infrared (IR), ultrasonic, and the like. Correspondingly, the controller 122 can execute logic for processing or otherwise using output of each of the sensors on the sensor platform 132. For example, with respect to cameras, the controller 122 can execute image processing logic to identify features in the images. Examples of image processing logic include, but are not limited to, facial recognition, edge detection, morphological, Gaussian, machine learning, neural network, and so forth—just to name a few.

The controller 122 can utilize a modified automatic high-beam algorithm when the vehicle is in an urban mode (enters area with sufficient road illumination). During any of these conditions, the controller 122 can deactivate ORA lights deactivated within one second (or another specified response period) of an ORA light disable event (e.g., when a hazard or other condition is detected). The ORA lights can be reactivated after triggering condition is resolved. For example, the vehicle passes by the oncoming and leading vehicles, parked vehicles, bicycles, pedestrians, and so forth. The controller 122 can use camera images and image processing to detect image shapes or outlines that are indicative of human or vehicle features. When a hazard is detected, the controller 122 can deactivate all or a portion of the ORA lights until the hazard is no longer detected.

In yet other examples, the controller 122 can disable ORA lights when lane markings are detected. For example, the controller 122 may utilize camera images to detect lane markings on a road. When lane markings are detected, the controller 122 can infer that the vehicle is operating on at least a category two, and possibly a category one road. The controller 122 can further infer whether the vehicle is on a category one or two road by consulting the navigation map and comparing the GPS location of the vehicle to roads on the navigation map.

As noted above, various GUIs can be presented to a user when ORA lighting is active, either due to manual activation or automatically by the controller 122. These GUIs can provide information to the driver and/or request information/confirmation from the user regarding ORA lighting. Messages can be dismissible (e.g., can be removed from view by a user after presentation). Some messages are persistently displayed, and some may include situational confirmation where ORA lighting is requested, the user confirms the vehicle is off-road, and a persistent message is displayed.

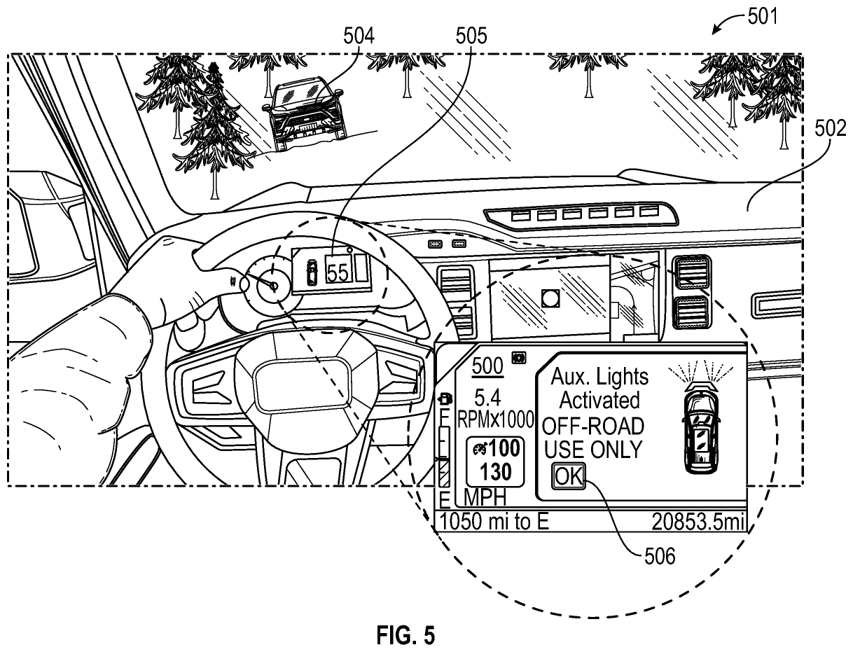

FIG. 5 illustrates the display of a GUI 500 during off-road use of a vehicle 502 in an environment 501. For context, the vehicle 502 is operating on a third category of road (e.g., off-road location). In this example, the vehicle is on a snow-packed road. When the controller of the vehicle detects that the vehicle is located in an off-road location, the controller can use sensors to detect hazardous conditions, such as an oncoming vehicle 504.

It is assumed that the ORA lighting has been activated, either manually by the user or the controller of the vehicle. When the ORA lighting is active, the GUI 500 can be displayed either transiently or persistently on an HMI or instrument cluster 505 of the vehicle. The GUI 500 includes a message that indicates that ORA lights are active and that only off-road use is permitted. The user can confirm that they acknowledge this message by pushing button 506.

When the oncoming vehicle is detected, the controller can cause the ORA lighting to deactivate until the vehicle 502 is past the oncoming vehicle 504. When the oncoming vehicle 504 has passed by the vehicle 502, the ORA lighting can be reactivated. If the vehicle were to leave the off-road area and enter a category two or category one road, the controller may enact a remediating measure, such as requesting that the driver confirm their location, or automatically deactivating the ORA lighting.

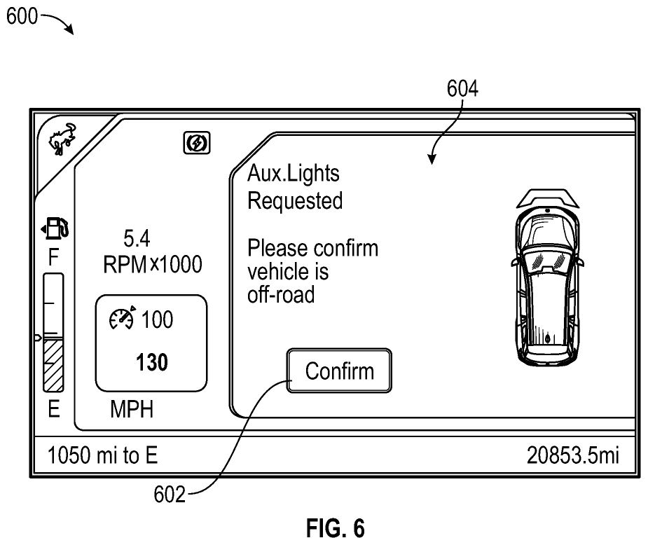

FIG. 6 illustrates another example GUI 600 that can be displayed. This GUI 600 is similar to the GUI 500 of FIG. 5, with the exception that the driver confirms that they intended to use ORA lighting using button 602, prior to activating the ORA lights. Thus, the GUI 600 includes a message 604 indicating that confirmation is requested for the auxiliary lights (e.g., ORA lighting).

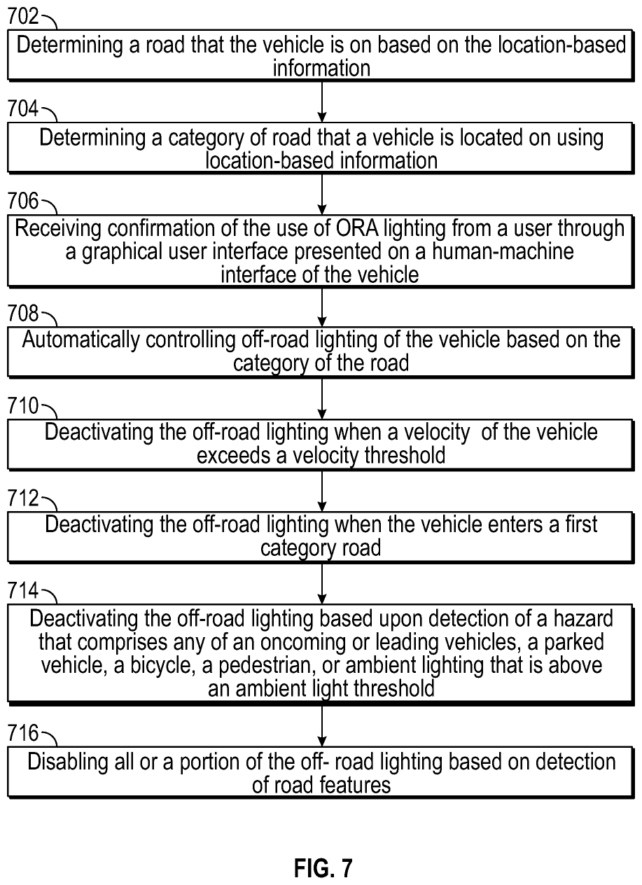

FIG. 7 is a flowchart of an example method of the present disclosure performed by a controller of a vehicle that is configured to automatically control operations of off-road lighting. The method can include a step 702 of determining a road that the vehicle is on based on the location-based information. As noted above, the lighting system monitors the vehicle's on/off-road status by comparing the vehicle's GPS location to a map database within the vehicle's navigation system.

The method can include step 704 of determining a category of the road that a vehicle is located on using location-based information. The map used by the navigation system can include information that indicates the types or categories associated with roads on the map.

As noted above, the category of the road is selected from any one of a first category where the use of the off-road lighting is not permitted, a second category where the off-road lighting is permitted to be activated with user confirmation and when a velocity of the vehicle is below a velocity threshold, and a third category where the off-road lighting is permitted regardless of speed. A first category of road comprises any of an interstate, a freeway, or an expressway. A second category of road comprises any of an arterial or a collector. A third category comprises any of an off-road vehicle (ORV), a trail, or private property.

The method can include an optional step 706 of receiving confirmation of the use of ORA lighting from a user through a graphical user interface presented on a human-machine interface of the vehicle. For example, the user can be requested to confirm that the vehicle is on the category of road that was determined by the controller.

The method can include step 708 of automatically controlling off-road lighting of the vehicle based on the category of the road. For example, off-road lighting can be automatically activated when the vehicle is on a category two or category three road.

The method can include step 710 of adjusting the off-road lighting when a velocity of the vehicle exceeds a velocity threshold. Adjusting can include dimming, deactivating, or other similar procedures. This may occur when the vehicle is on a second category road, but not when the vehicle is on a third category road. Again, when the vehicle is on a first category road all use of ORA lighting is prohibited. Thus, the method can include step 712 of adjusting the off-road lighting when the vehicle enters a first category road.

In some instances, the method can include step 714 of adjusting the off-road lighting based upon detection of a hazard that comprises any of oncoming or leading vehicles, a parked vehicle, a bicycle, a pedestrian, or ambient lighting that is above an ambient light threshold. Ambient light can be detected using a sunlight or solar sensor. The off-road lighting can be automatically reactivated when the hazard is no longer detected. The method can include step 716 of disabling all or a portion of the off-road lighting based on detection of road features.

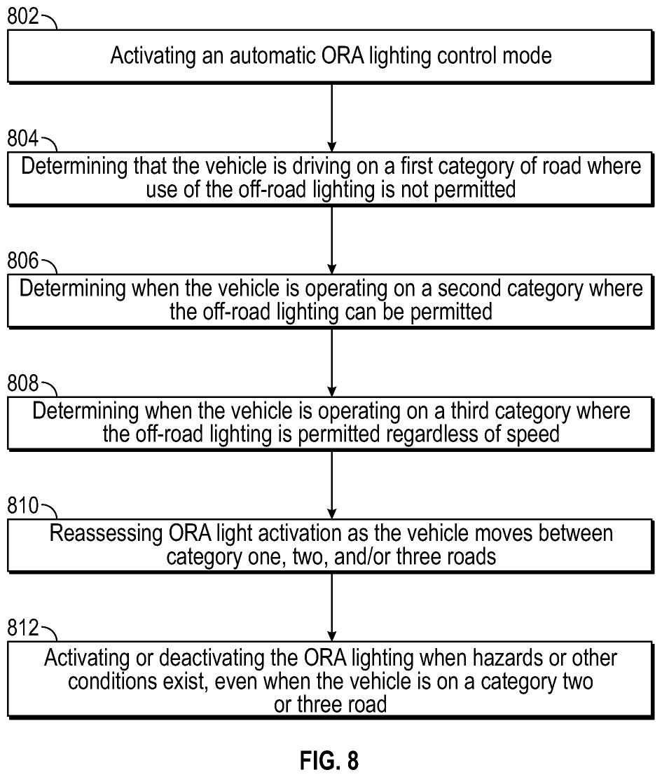

FIG. 8 is a flowchart of another example method. It will be understood that the vehicle is enabled with ORA lighting mode of operation. Thus, ORA lighting may be automatically controlled so as to turn on/off as disclosed herein. In some instances, automated ORA lighting control can track a current location of the vehicle and compare the location to navigation map information and determine a category of road the vehicle is operating on or near.

The method can include step 802 of activating an automatic ORA lighting control mode. As noted above, this can be executed manually by a user or through a controller when the vehicle is operating under certain conditions. The method can be performed by an ORA controller as disclosed above. The method can further include step 804 of determining that the vehicle is driving on a first category of road where use of the off-road lighting is not permitted. In these instances, when an ORA controller detects that the vehicle is on or near a first category of road, the ORA controller can deactivate and/or prevent activation of ORA lighting. In one example, ORA lighting is deactivated when the vehicle moves from an area where ORA lighting is permitted and active, such as when the vehicle is on an off-road permitted area.

The method can also include step 806 of determining when the vehicle is operating on a second category where the off-road lighting can be permitted. In some instances, the ORA lighting may be activated automatically but only after user confirmation has confirmed that ORA lighting should be activated. The activation of the ORA lighting may also be conditioned upon vehicle speed. Thus, the velocity of the vehicle should be below a velocity threshold prior to light activation. ORA lights can also be deactivated when the vehicle speed is above this threshold when the vehicle is on a second category of road.

The method can also include step 808 of determining when the vehicle is operating on a third category where the off-road lighting is permitted regardless of speed. The method can also include step 810 of reassessing ORA light activation as the vehicle moves between category one, two, and/or three roads. The method can include step 812 of activating or deactivating the ORA lighting when hazards or other conditions exist, even when the vehicle is on a category two or three roads.

Implementations of the systems, apparatuses, devices and methods disclosed herein may comprise or utilize a special purpose or general-purpose computer including computer hardware, such as, for example, one or more processors and system memory, as discussed herein. Computer-executable instructions comprise, for example, instructions and data which, when executed at a processor, cause a general-purpose computer, special purpose computer, or special purpose processing device to perform a certain function or group of functions. An implementation of the devices, systems and methods disclosed herein may communicate over a computer network. A “network” is defined as one or more data links that enable the transport of electronic data between computer systems and/or modules and/or other electronic devices.

Although the subject matter has been described in language specific to structural features and/or methodological acts, it is to be understood that the subject matter defined in the appended claims may not necessarily be limited to the described features or acts described above. Rather, the described features and acts are disclosed as example forms of implementing the claims.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed is:

1. A method comprising:
determining a category of a road that a vehicle is located on using location-based information; and
automatically controlling off-road lighting of the vehicle based on the category of the road.

2. The method according to claim 1, further comprising adjusting the off-road lighting when a velocity of the vehicle exceeds a velocity threshold.

3. The method according to claim 1, wherein the category of the road is selected from any one of:
a first category where use of the off-road lighting is not permitted;
a second category where the off-road lighting is permitted to be activated with user confirmation and when a velocity of the vehicle is below a velocity threshold; and
a third category where the off-road lighting is permitted regardless of speed or user confirmation.

4. The method according to claim 3, wherein the first category comprises any of an interstate, a freeway, or an expressway.

5. The method according to claim 4, wherein the second category comprises any of an arterial or a collector.

6. The method according to claim 5, wherein the third category comprises an off-road vehicle (ORV) road, a trail, private property, or off-road.

7. The method according to claim 6, further comprising:
determining when the road is of the second category; and
determining if a user has accepted a disclaimer before activating the off-road lighting.

8. The method according to claim 1, further comprising:
adjusting the off-road lighting based upon detection of a hazard that comprises any of an oncoming or leading vehicle, a parked vehicle, a bicycle, a pedestrian, or ambient lighting that is above an ambient light threshold; and
automatically reactivating the off-road lighting when the hazard is no longer detected.

9. The method according to claim 1, further comprising providing a graphical user interface having elements that allow a user to select all or a portion of the off-road lighting for activation or deactivation.

10. The method according to claim 1, further comprising:
determining a road that the vehicle is on based on the location-based information; and
receiving confirmation of the road from a user through a graphical user interface presented on a human-machine interface of the vehicle.

11. The method according to claim 1, further comprising disabling all or a portion of the off-road lighting based on detection of road features.

12. A vehicle comprising:
off-road lighting mounted to an outside of the vehicle; and
a controller comprising a processor and memory, the processor executing instructions in memory to:
determine a category of a road that the vehicle is located on using location-based information; and
automatically control the off-road lighting based on the category of the road.

13. The vehicle according to claim 12, wherein the category of the road is selected from any one of:
a first category where use of the off-road lighting is not permitted;
a second category where the off-road lighting is permitted to be activated with user confirmation and when a velocity of the vehicle is below a velocity threshold; and
a third category where the off-road lighting is permitted regardless of speed or user confirmation.

14. The vehicle according to claim 13, wherein the first category comprises any of an interstate, a freeway, or an expressway; the second category comprises any of a principal arterial, a minor arterial, or a major and/or minor collector; and the third category comprises any of an off-road vehicle road and/or trail, or private property.

15. The vehicle according to claim 12, wherein the controller is configured to:
monitor a velocity of the vehicle when the off-road lighting is active;
determining road features when the off-road lighting is active; and
deactivate the off-road lighting when the velocity of the vehicle exceeds a velocity threshold and/or when the road features are determined.

16. The vehicle according to claim 12, wherein the processor is configured to:
deactivate the off-road lighting based upon detection of a hazard that comprises any of an oncoming or leading vehicle, a parked vehicle, a bicycle, a pedestrian, or ambient lighting that is above an ambient light threshold; and
automatically reactivate the off-road lighting when the hazard is no longer detected.

17. The vehicle according to claim 12, further comprising a human-machine interface, wherein the processor is configured to provide a graphical user interface on the human-machine interface, the graphical user interface having elements that allow a user to select all or a portion of the off-road lighting for activation.

18. A method comprising:
activating an automatic off-road auxiliary (ORA) lighting control mode of a vehicle;
deactivating or preventing activation of ORA lighting when the vehicle is driving on a first category road where use of the ORA lighting is not permitted;
activating the ORA lighting when the vehicle is operating on a second category road where the off-road lighting is permitted, with a condition that comprises any of receiving confirmation that the vehicle is operating on the second category road or vehicle speed being below a velocity threshold; and
activating the ORA lighting when the vehicle is operating on a third category road where the off-road lighting is permitted regardless of speed or user confirmation.

19. The method according to claim 18, further comprising reassessing ORA light activation as the vehicle moves between the first category road, the second category road, and the third category road.

20. The method according to claim 18, further comprising activating or deactivating the ORA lighting when a hazard is detected, when the vehicle is on the first category road or the second category road.
